(19) United States
(12) Patent Application Publication
(10) Pub. No.: US 2024/0302475 A1
(43) Pub. Date: Sep. 12, 2024

(54) LIGHTWEIGHT CALIBRATION METHOD FOR DIRECTION FINDING

(71) Applicant: The Regents of the University of Colorado, a body corporate, Denver, CO (US)

(72) Inventors: Gaeron R. Friedrichs, Milford, PA (US); Mohamed Ali Elmansouri, Broomfield, CO (US); Dejan S. Filopovic, Lafayette, CO (US)

(21) Appl. No.: 18/601,079

(22) Filed: Mar. 11, 2024

Related U.S. Application Data
(60) Provisional application No. 63/451,483, filed on Mar. 10, 2023.

(51) Int. Cl. G01S 3/02; G01S 3/04

(52) U.S. Cl. CPC G01S 3/026; G01S 3/043

(57) ABSTRACT

A direction finding system can be configurable to: (i) access a baseline neural network initially configured to imitate behavior of a two-argument arctangent function; (ii) apply transfer learning to the baseline neural network to generate a calibrated neural network, wherein the transfer learning calibrates the baseline neural network to perform Watson-Watt direction finding without utilizing a lookup table for error correction; (iii) access measurement data acquired via the direction finding sensor array; (iv) generate preprocessed data by applying one or more preprocessing operations to the measurement data; (v) utilize the preprocessed data as input to the calibrated neural network; and (vi) output angle of arrival data, the angle of arrival data comprising output of the calibrated neural network.

### CROSS-REFERENCE TO RELATED APPLICATIONS

This application claims priority to U.S. Provisional Application No. 63/451,483, filed on Mar. 10, 2023, and entitled “LIGHTWEIGHT CALIBRATION METHOD FOR DIRECTION FINDING”, the entirety of which is incorporated herein by reference for all purposes.

### STATEMENT REGARDING GOVERNMENT RIGHTS

This invention was made with government support under grant number N00014-21-1-2641, awarded by the Office of Naval Research, and grant number DGE1650115, awarded by the National Science Foundation. The government may have certain rights in the invention.

### BACKGROUND

Direction finding (DF) has long since been an interest of the radio frequency (RF) community for its immense applications in both the commercial and defense space. The Watson Watt (WW) method for DF is a traditional, simple, low-cost, and widely used implementation for determining the azimuthal angle of arrival of a signal. Unfortunately, this approach can incur a variety of biasing errors, and often requires a look-up-table (LUT) for calibration. Calibration is another area of interest in the context of uniform circular arrays and WW like architectures.

The subject matter claimed herein is not limited to embodiments that solve any challenges or that operate only in environments such as those described above. Rather, this background is only provided to illustrate one exemplary technology area where some embodiments described herein may be practiced.

### SUMMARY

Disclosed embodiments include a stream-lined approach that can be applied to multiple different direction finding (DF) systems in a systematic way that allows for the rapid calibration of systems. Radio direction finding is the process of determining a signals angular location/source using one or more antennas. A common form of direction finding systems utilizes a Watson-Watt (WW) system. To calibrate these systems, often large, cumbersome lookup-tables and correction factors are applied. In at least one embodiment, the calibration is packaged on a lightweight model of a trigonometric response (2-argument arctangent), which allows for the rapid, lightweight calibration of the system given that the system conforms to a trigonometric output. The calibration “data” may take up significantly less space, allowing for many different calibration states (operational situations) to be stored with respect to a single operational state in a conventional system. As such, disclosed embodiments allow for time and (digital) footprint/space savings.

Disclosed embodiments teach a transfer learning system and neural network (NN) system that is configured to calibrate a DF system. In at least one embodiment, using the WW DF approach, a pretrained neural network that imitates the a tan 2 function is retrained using a limited number of samples. The NN system can be trained to operate in a number of different environment on a number of different systems.

In at least one embodiment, disclosed systems require less storage space than conventional look-up tables. Further, disclosed systems provide efficiency benefits in that users need only learn a single system of calibration. As such, calibrating a system in the real world utilizes a repeatable and relatively simple calibration stem needed to train the NN.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a conceptual representation of aspects of a Watson-Watt direction finding system, according to implementations of the subject matter described herein.

FIG. 2 illustrates a conceptual representation of a two-argument arctangent neural network implementation (ataNN2), according to implementations of the subject matter described herein.

FIG. 3 illustrates direction finding error with respect to the angle of arrival for multiple neural networks trained using transfer learning, according to implementations of the subject matter described herein.

FIG. 4 illustrates a four-element uniform circular array of monopoles with element-wise radomes that is deployable as a Watson-Watt direction finding sensor array, according to implementations of the subject matter described herein.

FIGS. 5A, 5B, 5C, and 5D illustrate measured radiation patterns acquired via monopoles of the sensor array of FIG. 4, according to implementations of the subject matter described herein.

FIG. 6 illustrates an example comparison of theoretical radiation patterns and measured Watson-Watt radiation patterns, according to implementations of the subject matter described herein.

FIG. 7 illustrates measured root mean square error (RMSE) and maximum error for angle of arrival measurement results achieved by a sensor array implementing an ataNN2 network, according to implementations of the subject matter described herein.

FIGS. 8, 9, and 10 illustrate example flow diagrams depicting acts associated with implementations of the subject matter described herein.

FIG. 11 illustrates an example system that may comprise or implement one or more disclosed embodiments.

### DETAILED DESCRIPTION

Disclosed embodiments are directed to systems, methods, devices, and/or techniques that achieve lightweight calibration for direction finding.

### Introduction

As noted above, the WW approach for DF can incur a variety of biasing errors and often requires an LUT for calibration. Various approaches have been developed to improve the performance of DF systems at the antenna level. For example, radiation pattern criteria, even for amplitude-only direction finding has been developed. RF structure-based solutions have been demonstrated to ultimately yield better output spectra of DF algorithms. Time-domain approaches even seek to create pattern modes that can be exploited for higher accuracy DF. However, most implementations still require a LUT to some degree.

Machine learning (ML) may be used to achieve faster look-up times with a smaller footprint when compared to a LUT. However, training a network for a specific implementation raises questions regarding the logistics of calibrating these niche neural networks (NNs) that are deployed with complex DF systems (e.g., a transfer learning (TL) problem). TL is a method where NNs are retrained, in small proportion, to adapt to a new scenario. In this case, it is with the goal of maintaining accuracy when the DF system is deployed.

WW maintains relevance in modern times due to the achievable level of accuracy from a compact, low complexity system operating at HF (high frequency), VHF (very high frequency), and UHF (ultra-high frequency). Methods of miniaturizing such systems have been developed and further solidified WW for applications such as vehicle safety. These concepts are extended further, as is WW's utility through the miniaturization and integration of the system into the wearable electronics realm.

### Watson Watt Direction Finding

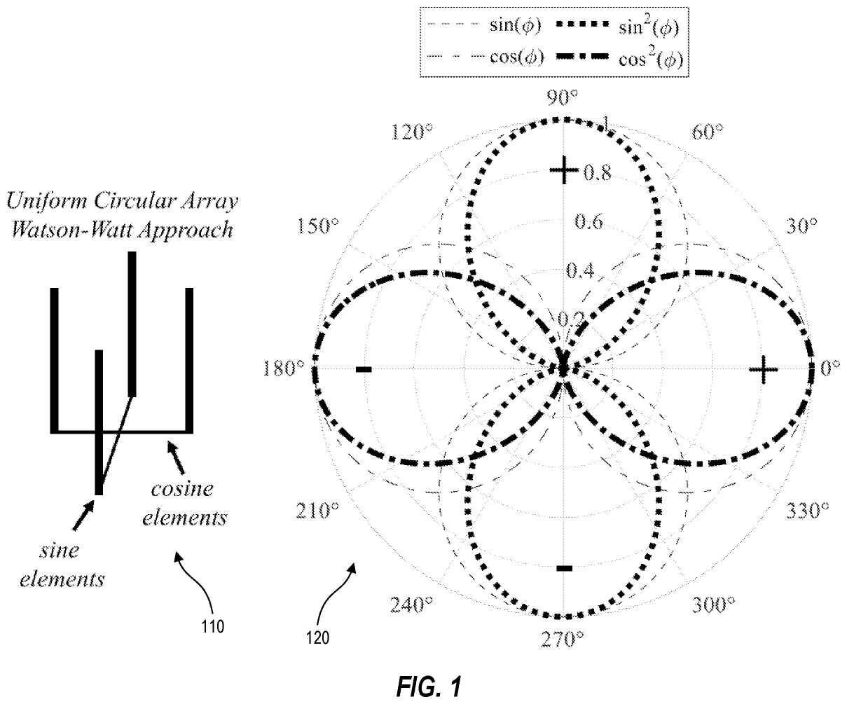

WW techniques often leverage two channels: one with a sine response as a function of azimuth, and one with a cosine response as a function of azimuth. Achieving such a response typically is done using four element circular arrays, with or without a sense antenna. The elements are beamformed to provide the magnitude of the sinusoidal response, while the sense functionality (implemented herein with four-channel power detection) is used to resolve the polarity. A simple depiction of a WW DF system is shown in FIG. 1, which shows a WW element arrangement 110. FIG. 1 also provides a graph 120 showing ideal radiation patterns (denoted by the sin(ϕ) and cos(ϕ) lines) and non-ideal radiation patterns (denoted by the sin²(ϕ) and cos²(ϕ) lines). The non-ideal radiation patterns are utilized in experimental results described herein.

With one set of elements, North/South (NS), yielding a cosine pattern, and the other set of elements, East/West (EW), yielding a sine pattern, the angle-of-arrival can then be retrieved through the two-argument arctangent, referred to herein as a tan 2. This function has been widely implemented on a variety of hardware—including solutions for hardware without multipliers, CORDIC (coordinate rotation digital computer), and modern alternatives for FPGAs (field-programmable gate arrays). This, however, does not address the issue when the system produces patterns that are not perfect representations of the sinusoids. In this case, LUTs are often implemented to error correct the estimation provided by a tan 2. When deploying a system, the LUT correction is typically applied after the a tan 2 implementation and populated with values measured from the operational scenario.

Disclosed embodiments are directed to an approach for replacing the combination of a tan 2 and error correcting LUT with a NN that can accomplish both purposes. Because the WW architecture is relatively generic with respect to circular arrays, disclosed embodiments involve training a NN to perform WW on analytical radiation patterns, then using TL to minimize the number of points required for array calibration. Such techniques can eliminate the need for a LUT. Implementations of the disclosed techniques can allow for streamlined DF processing algorithm deployment across a variety of sensors, if operating as a WW array, that can help mitigate the impact of mutual coupling, platform installation, and element deterioration with a single, unified procedure.

### Neural Network Arctangent

The two-argument arctangent has a discontinuity in its range at an input angle of π. Angle wrapping occurs from +180 to −180° in the middle of its domain. This causes the network to try to produce drastically different outputs (+180°, −180°) for identical inputs. An efficient remediation is to fit only half the domain. In such a case, only the upper half of the unit circle (ϕ∈[0,π]) would need to be used to train the network. The Y input of a tan 2, if not positive, would be fed to the network with a reversed polarity, and the resulting output of the network would also require a polarity reversal.

However, such an approach would rely on symmetry across the NS axis. This assumption is limiting when utilizing realistic radiation patterns. Generally, calibration of all the elements is desired—symmetry is therefore an assumption that vitiates such approaches. Thus, an a tan 2 NN implementation (ataNN2) described herein can comprise two NNs for recreating or imitating the behavior of a tan 2. In some embodiments, the two networks are identical; they are two instances of a single network. The use of each network can be determined by the polarity of the EW response (e.g., the sign of the sine pattern). If the sign is positive, the first network is used. If the sign is not positive, the second network is used, which includes a −180° post-processing step.

By utilizing multiple instances of a single network for ataNN2, as described herein, the initial training can produce a single network. However, both copies of that network can facilitate the use of transfer learning with asymmetric radiation pattern impacts. Additional details related to transfer learning in accordance with the disclosed subject matter will be provided hereinafter.

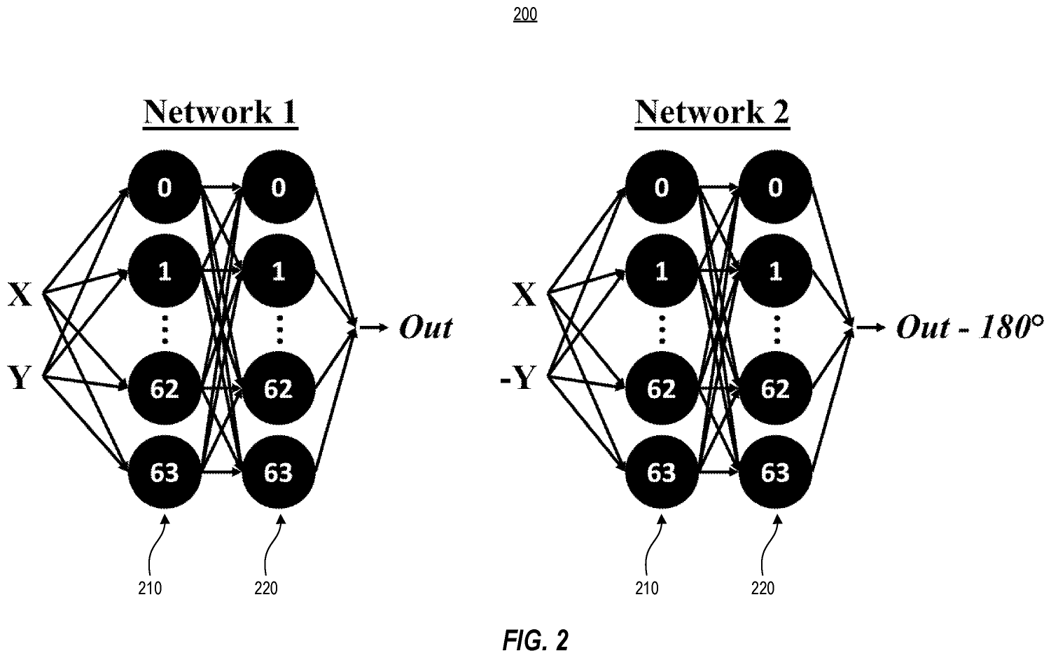

In one example implementation, the baseline training of the ataNN2 network 200 (comprising Network 1 and Network 2) can be implemented with two hidden layers 210 and 220 of width 64, as shown in FIG. 2. In the example shown in FIG. 2, each hidden layer 210 and 220 can utilize a tanh activation function. One will appreciate, in view of the present disclosure, that the individual networks of an ataNN2 network can have different configurations (e.g., different widths or quantities of neurons per layer, different quantities of layers, different activation functions, etc.)

In some implementations, Network 1 of the ataNN2 network 200 can handle inputs with a positive Y input, and Network 2 of the ataNN2 network 200 can handle inputs with a negative Y input. Network 2 can invert the negative Y input such that ultimately the input is positive. In some examples, the resulting network pair can feature a root mean square error (RMSE) of less than 0.06°.

### Transfer Learning Calibration

According to the disclosed techniques, TL can entail taking a baseline WW NN pair (e.g., ataNN2, as shown and described with reference to FIG. 2) and retraining it using a minimum number of points to minimize the DF error for deteriorated radiation patterns. Traditionally, LUTs are often stored with some resolution based on system level requirements (e.g., where beam measurements are stored every 0.5° or 1° depending on the desired resolution).

Alternatively, fewer points can be used with some predefined function that helps represent the patterns using that smaller set of points. Disclosed embodiments can implement retraining of a preexisting NN to achieve this function. Such an approach can effectively front load the computational overhead to the initial training (e.g., which can occur once) and the transfer learning (e.g., which can occur for each calibration). In some implementations, the overhead at runtime can be fixed, in contrast with situations with complex calibration functions due to few points, or larger LUTs.

In some instances (e.g., to achieve the experimental results described herein), the elements can be assumed to be more directive than designed, such as the elements denoted by sin²(ϕ) and cos²(ϕ) in FIG. 1, which can comprise a simple model of pattern degradation that can represent the applicability of this disclosed techniques to arrays with manufacturing tolerance issues, mutual coupling effects, and installed performance impacts. In some instances (e.g., to achieve the experimental results described herein) the beam maximum and minimum can be fixed, as well as the location of the beam crossovers.

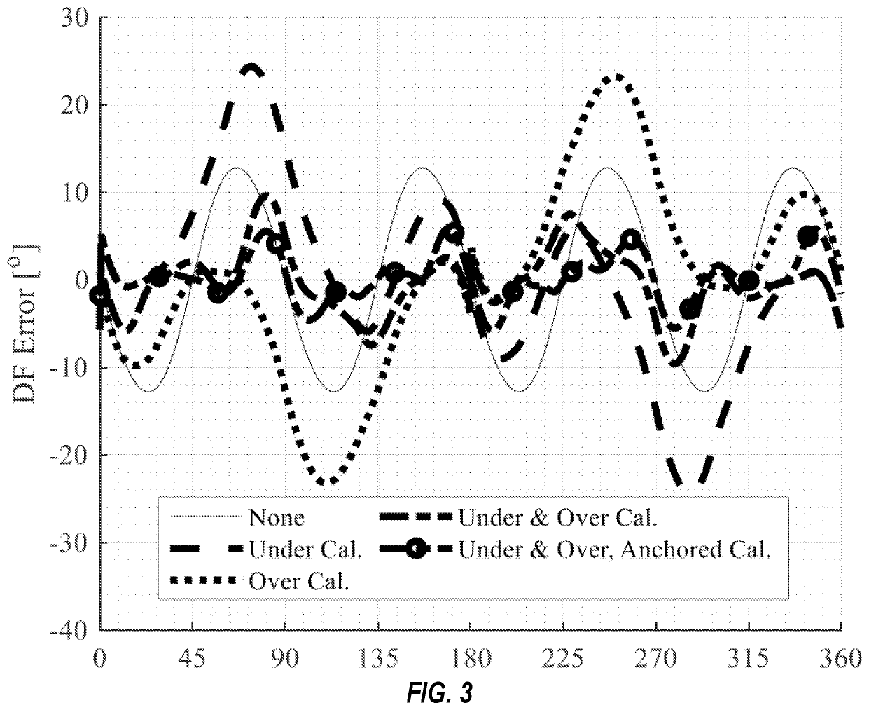

FIG. 3 illustrates the DF error with respect to the angle of arrival for multiple NNs trained using TL, as described herein. FIG. 3 shows the impact of changing the directivity of the elements on the error of the DF estimate. For a four-element array, there are eight known anchor points: the beam peaks for each element (0°, 90°, 180°, and 270°) and the beam crossovers for each element pair (45°, 135°, 225°, and 315°). These anchor points see no error, since their relative values always remain the same, regardless of constrained beam shape distortions.

Several different TL situations can be pursued according to the different subsets of augmented data. In some instances, the augmented data represents the samples that would be used to calibrate the array. In FIG. 3, the solid curve (labeled “None”) shows the direction finding error—that is, the difference between the estimated angle and the actual angle. Values greater than zero are referred to as estimation overshoot, and values less than zero are referred to as estimation undershoot. In some embodiments, the network pair is first retrained with data from the overshoot regions (67.5°, 157.5°, 247.5°, and 337.5°); then, retraining is repeated for data from the undershoot regions (22.5°, 112.5°, 202.5°, and 292.5°); then, both overshoot and undershoot regions are used; then, the TL is performed with the known, theoretical anchor points as a part of the dataset. Example RMSE results achieved for NNs trained as described above are shown in FIG. 3, with the “Over Cal.” line corresponding to the calibration using data from the overshoot regions, with the “Under Cal.” line corresponding to the calibration using data from the undershoot regions, with the “Under & Over Cal.” line corresponding to the calibration using data from both the overshoot and the undershoot regions, and with the “Under & Over, Anchored Cal.” line corresponding to the calibration using data from both the overshoot and the undershoot regions, with the known, theoretical anchor points being included in the data.

In some implementations, while initially the partial transfer learning datasets may sound appealing, since only four samples are used and the error is reduced in those regions, the overall RMSE can be observed to increase when compared to the uncalibrated array. For instance, with reference to FIG. 3, the uncalibrated curve (solid, labeled “None”) has an RMSE of 9.19°, while the undershoot calibration (dashed, labeled “Under Cal.”) has an RMSE of 10.73° and the overshoot calibration (dotted, labeled “Over Cal.”), as expected, also has an RMSE of 10.73°. Intuitively, the results show that the more training data diversity, the better; the combined overshoot and undershoot calibration (dash-dot, labeled “Under & Over Cal.”) reaches a reduced RMSE of 3.74°. The addition of anchor points in the data set (dash-dot-circle, labeled “Under & Over, Anchored Cal.”) yields a further improved RMSE of 2.67°.

Extending these sampling/calibration points further can improve the performance of the system. In one well-performing example implementation (from which the experimental results described herein were obtained), only four measurements per network were used, and the TL process took 1-5 seconds per network on an Intel Xeon CPU. A significant increase in measurement quantity and calibration data can increase the transfer learning overhead incurred, however, it still can be more attractive than the scalability of a LUT. Ultimately, the desired calibration quality, measurements performed, and overhead incurred can be selected based on the implementation environment and operator preferences.

TL datasets for calibrating a baseline ataNN2 network can comprise measurement points/data and ground truth angle of arrival data. The measurement points/data can be raw or preprocessed as described herein. TL datasets for calibrating a baseline ataNN2 network can comprise anchor points (e.g., corresponding to beam peaks and/or beam crossovers).

### Experimental Results and Validation

To provide sufficient validation of the techniques, methods, and principles described herein, experimental results were obtained. It shall be noted that these experimental results and the experiment(s) that yielded the results are provided by way of illustration and were performed under specific conditions using a specific embodiment or embodiments; accordingly, neither these experiments nor their results shall be used to limit the scope of the disclosure of the current patent document.

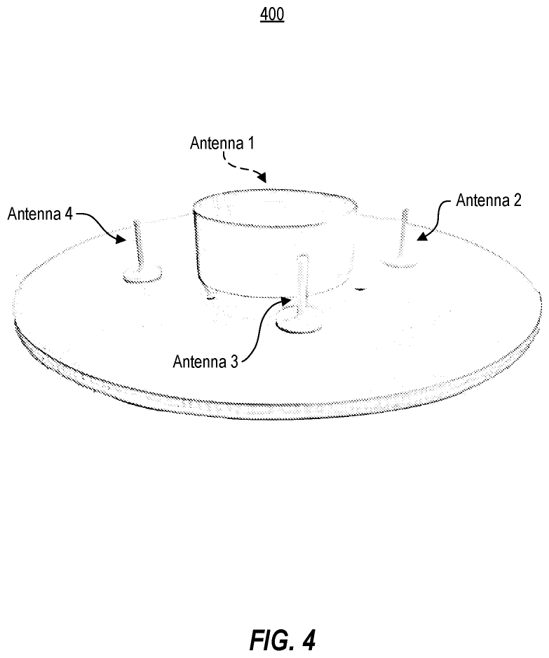

FIG. 4 illustrates a four-element uniform circular array 400 of monopoles with element-wise radomes, which is deployable as a WW DF sensor array. As shown in FIG. 4, the array 400 includes antenna 1 (labeled as such in FIG. 4, though antenna 1 is obscured by other elements in the view of the array 400 captured in FIG. 4), antenna 2 (labeled as such in FIG. 4), antenna 3 (labeled as such in FIG. 4), and antenna 4 (labeled as such in FIG. 4). The following discusses digital preprocessing for operating the array 400 with WW according to the present disclosure (e.g., implementing an ataNN2 network), and the corresponding measured patterns. In the following discussion, DF performance is analyzed both with and without calibration using measured radiation patterns in the presence of mutual coupling.

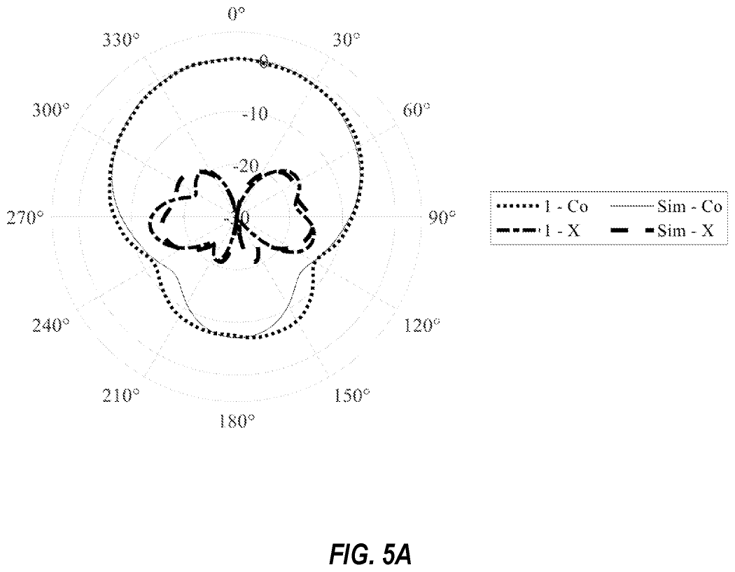

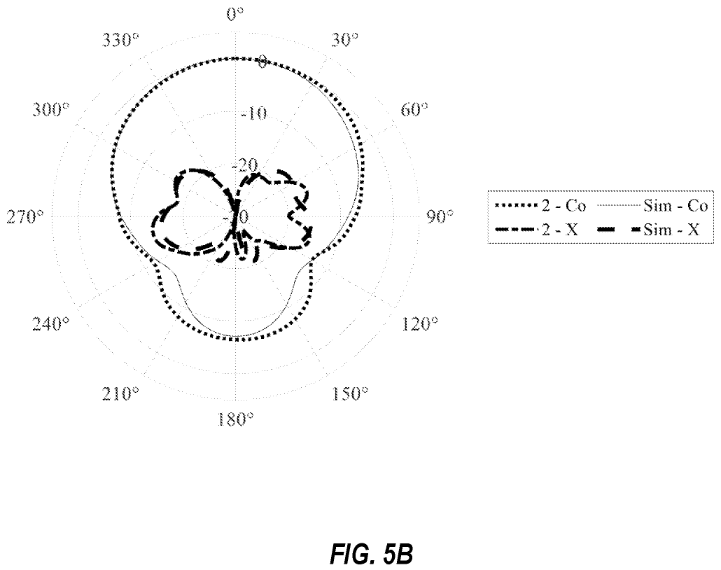

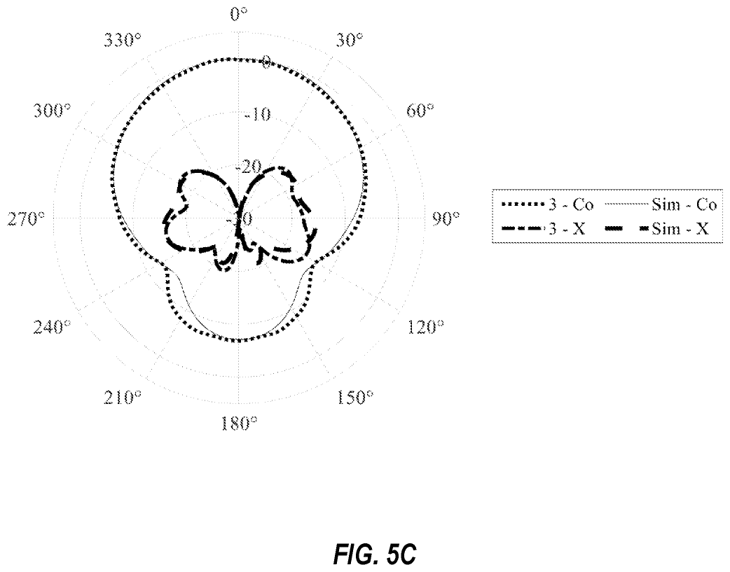

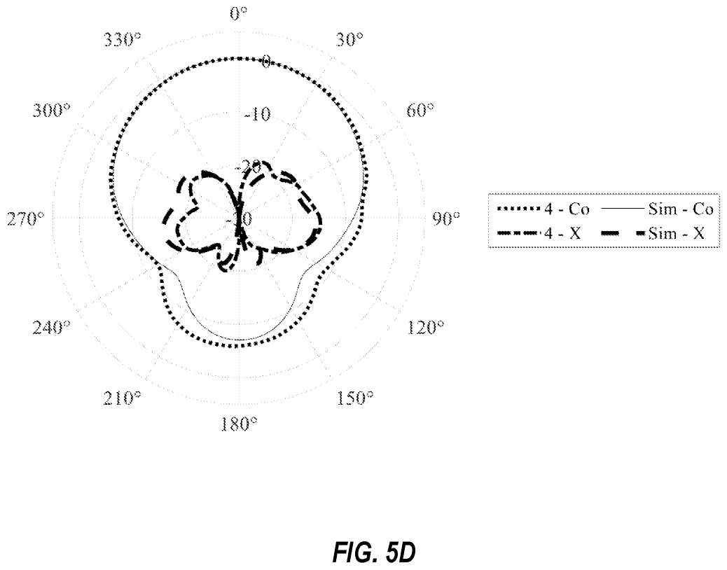

Digital preprocessing can help provide a far-field response that cooperates well with ataNN2 network implementation. In some embodiments, the preprocessing provides a mapping from the radiation patterns of four-element array 400 to sine and cosine patterns that can be leveraged with WW. For one example, the measured radiation patterns from all four monopoles (i.e., antenna 1, antenna 2, antenna 3, and antenna 4) are shown in FIGS. 5A, 5B, 5C, and 5D. FIGS. 5A through 5D illustrate measured radiation patterns for the various antennae of the array 400 at θ=90° and at 2.45 GHz. In FIGS. 5A through 5D, each line representing a measured radiation pattern is labeled with the applicable antenna number (e.g., “1”, “2”, “3”, or “4”) followed by a dash and an “X” label. In FIGS. 5A through 5D, each line representing a sine or cosine pattern achieved via mapping of a corresponding measured radiation pattern is labeled with the applicable antenna number (e.g., “1”, “2”, “3”, or “4”) followed by a dash and a “Co” label. FIGS. 5A through 5D each include a line representing a simulated measured radiation pattern for θ=90° and 2.45 GHz (labeled as “Sim −X”) and a line representing a simulated sine or cosine pattern (labeled as “Sim −Co”) achieved via mapping of the simulated measured radiation pattern, which are presented for qualitative assessment of pattern similarity (and which show validation of the disclosed techniques).

The mapping of measured patterns/signals can allow the aforementioned array 400 to function with WW. In some embodiments, the mapping leverages the fact that the combined patterns (NS₀,EW₀) of the NS and EW elements already produce a sinusoid-like pattern. With this behavior, and for a four-channel amplitude receiver, the maximum power from the NS and the EW channel pairs can be recorded, and powers from S and E incur a polarity change. After recordation (and polarity change for powers from and), the maximum powers are fit to the unit circle with the vector norm. This ultimately preserves the direction, and yields NS₁ and EW₁.

In some implementations, the new sinusoid-like radiation patterns will have a maximum value of 1 and an amplitude corresponding to 1−NS₁(90°)≈1−NS₁(180°) and 1−EW₁(0°)≈1−EW₁(180°). In some instances, with sufficient discrimination between NS and EW patterns at the primary axes, the amplitude of the patterns will be 1, and a fixed-value offset will not need to be considered.

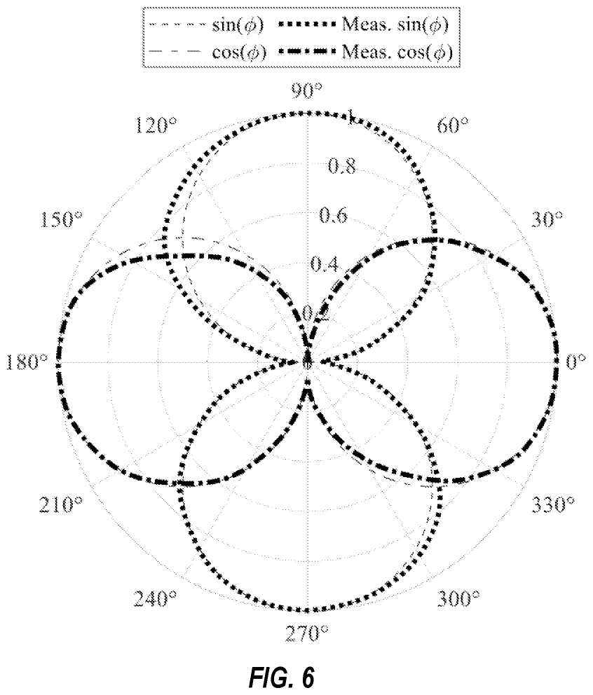

In some instances (e.g., for the array 400 of FIG. 4), the NS/EW discrimination is not extremely high at the primary axes. This can cause the supposed zero crossings to have a fixed-value offset which can significantly deteriorate DF performance. Thus, in some implementations, the offset is removed from the received signal (using one to four measured calibration points), yielding NS₂ and EW₂ (to achieve the experimental results described herein, only one calibration point was taken). After offset removal, the values can be refit to the unit circle using the same vector norm procedure discussed above. Example resulting radiation patterns are shown in FIG. 6, which shows theoretical radiation patterns (denoted by the sin (ϕ) and cos (ϕ) lines) versus measured WW radiation patterns (denoted by the “Meas. sin (ϕ)” and “Meas. cos (ϕ)” lines) at θ=90° and at 2.45 GHz. High receiver sensitivity can improve results.

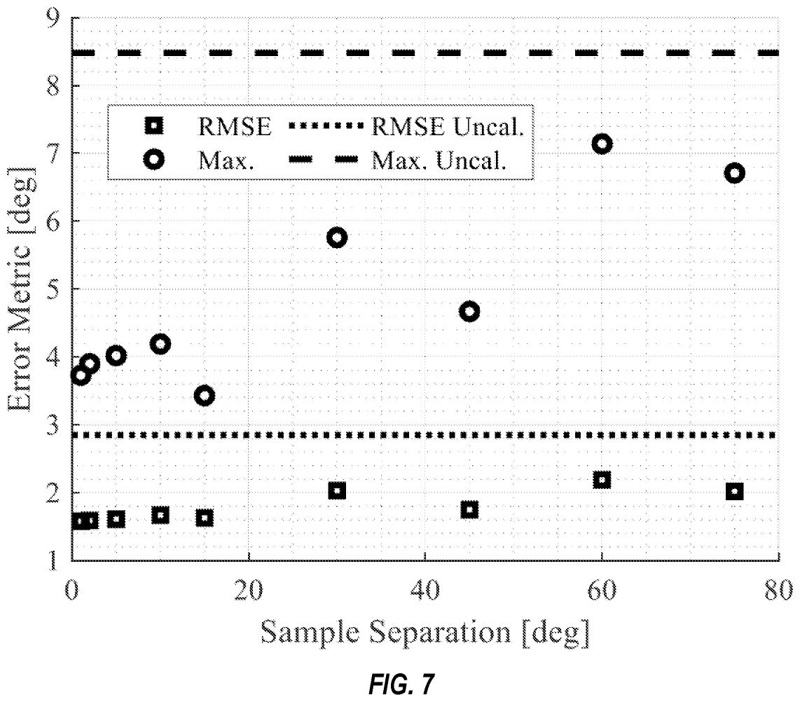

In one example experiment, the performance of the array 400 (implementing an ataNN2 network) was measured without calibration. In a noiseless environment, the array 400 achieved an RMSE of 2.85° and a maximum error of 8.48°. The calibration procedure was then performed. Measurement points were swept as a function of angular separation with results shown in FIG. 7, which shows the measured RMSE and maximum error results for angle of arrival measurements achieved by the array 400 implementing an ataNN2 network without calibration (labeled as “RMSE Uncal.” and “Max. Uncal.”) and with calibration (labeled as “RMSE” and “Max.”) for a variety of TL datasets. The measurement points went through digital preprocessing (as described above), then were provided as input to the two networks that make up ataNN2 (e.g., ataNN2 network 200). Analytical anchor points were also included (e.g., beam peaks for each element and beam crossovers for each element pair). The retraining process took a total of 13 seconds for both networks of the ataNN2 network on an Intel Xeon CPU. The retraining was performed over 125 epochs, with a batch size of 4 (other hyperparameters can be used in other implementations). Each training sample was replicated eight times. Calibrating every 45° was found to achieve desirable results, with respect to both accuracy and number of samples needed. The cardinal directions were omitted, so only four calibration points were used for training, and one additional point for the preprocessing. As is evident from FIG. 7, the RMSE was reduced by 38.60% through calibration, from 2.85° to 1.75°, and the maximum error was similarly reduced, from 8.48° to 4.67°—a 44.93% reduction.

Utilizing an ataNN2 network to facilitate DF, as described herein, can operate on the basis of the output data of a sensor manifold (e.g., array 400) being transformable to a WW-like response (e.g., via the mapping described hereinabove). The width and/or the depth of the default networks of an ataNN2 network (e.g., Network 1 and Network 2 of ataNN2 network 200) can be selected or adjusted to capture deviations that can result from more complex pattern deterioration from ideal WW patterns.

Utilizing an ataNN2 network to facilitate DF, as described herein, can achieve various benefits relative to other DF approaches, which attempt minimization through calibration constants, mutual coupling matrices (MCM), or error terms. In some approaches, MCM is utilized but heavily relies on analytical expressions that may not translate well to other antenna elements. Many existing DF approaches utilize both amplitude and phase information, whereas only amplitude information is utilized in the presently disclosed embodiments. Some existing DF approaches rely on strict symmetry enforcement, whereas the presently disclosed embodiments can avoid such an assumption. Other existing DF approaches leverage complicated infrastructure, such as a preexisting radar target detection and corresponding doppler information to determine pattern fluctuations, which can be difficult to implement. Some techniques use an error correcting network with a limited field of view, which can add complexity, in contrast with the presently disclosed embodiments, which can reduce complexity (e.g., by utilizing a single ataNN2 network to achieve both angle of arrival determination and error correction) and provide a streamlined procedure.

The embodiments disclosed herein can provide a standardized NN (e.g., ataNN2) for direction finding purposes and leveraging transfer learning to provide light-weight calibration of an antenna array. According to the disclosed subject matter, using the WW DF approach, a pretrained neural network that imitates the a tan 2 function can be retrained using a limited number of samples. Implementations of the disclosed embodiments can facilitate avoiding application specific NNs, as long as the sensor systems conform to the WW methodology. Where the sensor system conforms to the WW methodology, one standardized NN system, ataNN2, can be deployed to all sensor systems that do conform, and the calibration steps can be standardized across all platforms. Such benefits can be prominent when considering fielding a suite of different DF systems that all need quick, lightweight calibration capabilities. Compared with existing WW DF approaches, the embodiments disclosed herein can achieve greater accuracy, lower cost, and/or lower complexity.

### Example Method(s)

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

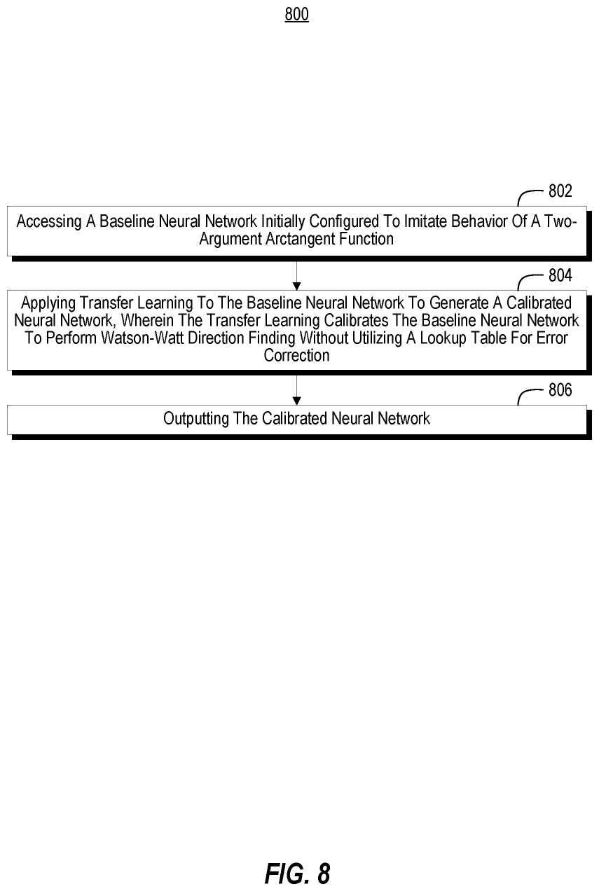

FIGS. 8, 9, and 10 illustrate example flow diagrams 800, 900, and 1000, respectively, depicting acts associated with lightweight calibration for direction finding.

Act 802 of flow diagram 800 of FIG. 8 includes accessing a baseline neural network initially configured to imitate behavior of a two-argument arctangent function. The baseline neural network can correspond to an initially trained ataNN2 network (e.g., ataNN2 network 200) prior to calibration. In some instances, the baseline neural network comprises a first neural network and a second neural network (e.g., similar to Network 1 and Network 2 of the ataNN2 network 200 shown in FIG. 2). In some implementations, the first neural network and the second neural network comprise separate instances of a single initially trained neural network. In some examples, the baseline neural network is configured to receive input comprising a sine pattern (e.g., yielded by EW elements) and a cosine pattern (e.g., yielded by NS elements).

In some instances, the use of the first neural network and the second neural network of the baseline neural network is determined by the polarity of the EW response (e.g., the sine pattern). For instance, the baseline neural network can be configured to: (i) process the input using the first neural network when a sign of the sine pattern is positive; and (ii) process the input using the second neural network when the sign of the sine pattern is negative. In some implementations, processing the input using the second neural network comprises applying a sign change to the sine pattern (e.g., Network 2 can invert the negative Y input such that the input processed is positive, as discussed hereinabove with reference to the ataNN2 network 200 shown in FIG. 2). In some examples, processing the input using the second neural network comprises applying a post-processing angle transformation to output of the second neural network (e.g., processing with Network 2 can include a −180° post-processing step, as indicated in FIG. 2 by the “Out −180°” following Network 2).

Act 804 of flow diagram 800 includes applying transfer learning to the baseline neural network to generate a calibrated neural network, wherein the transfer learning calibrates the baseline neural network to perform Watson-Watt direction finding without utilizing a lookup table for error correction. In some implementations, applying transfer learning to the baseline neural network comprises retraining the first neural network and the second neural network utilizing transfer learning data comprising measurement data and ground truth angle of arrival data. In some instances, the transfer learning data further comprises anchor point data associated with one or more beam peaks or one or more beam crossovers (e.g., for a four-element array, such as array 400, beam peaks for each element can comprise 0°, 90°, 180°, and 270°, and beam crossovers for each element pair can comprise 45°, 135°, 225°, and 315°).

Act 806 of flow diagram 800 includes outputting the calibrated neural network. The calibrated neural network can be used to perform WW DF and can be recalibrated as needed.

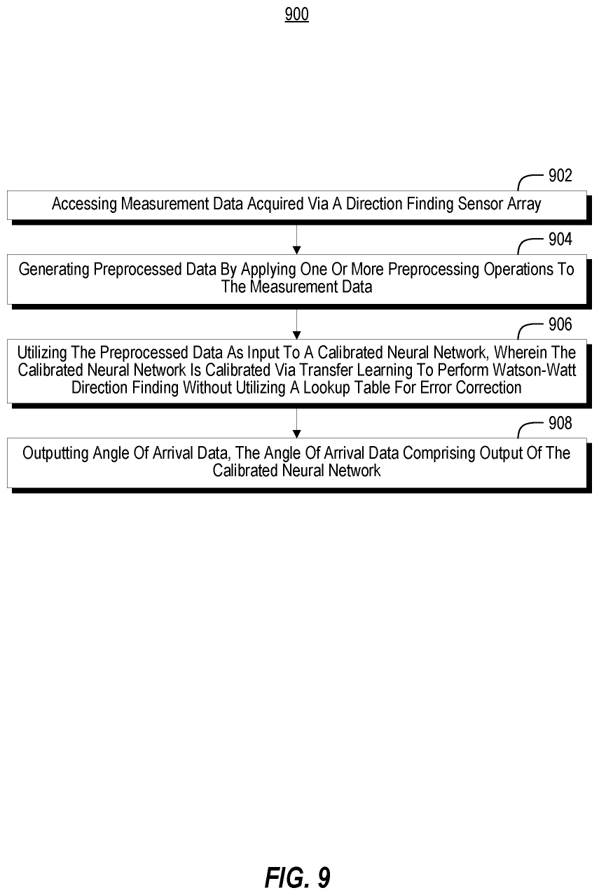

Act 902 of flow diagram 900 of FIG. 9 includes accessing measurement data acquired via a direction finding sensor array. In some implementations, the direction finding sensor array can correspond to array 400 described hereinabove. For instance, the direction finding sensor array can comprise a uniform circular array of monopoles, and the uniform circular array of monopoles can comprise a four-element array. In some instances, the measurement data comprises radiation pattern data (e.g., example radiation pattern or measurement data acquired by different monopoles of an array 400 are shown in FIGS. 5A, 5B, 5C, and 5D).

Act 904 of flow diagram 900 includes generating preprocessed data by applying one or more preprocessing operations to the measurement data. In some examples, applying the one or more preprocessing operations to the measurement data comprises mapping the radiation pattern data to sine pattern data (e.g., to imitate sine patterns yielded by EW elements, such as EW₁) and cosine pattern data (e.g., to imitate cosine patterns yielded by NS elements, such as NS₁). In some instances, mapping the radiation pattern data to the sine pattern data and the cosine pattern data comprises (i) determining maximum power of different channel pairs (e.g., NS and EW channel pairs), (ii) changing polarity of at least one channel from each of the different channel pairs (e.g., the S and E channels can incur a polarity change), and, after changing polarity, fitting channel pair data to a unit circle via vector norm (e.g., to obtain NS₁ and EW₁, as described hereinabove). In some implementations, the one or more preprocessing operations comprise an offset removal operation (e.g., to obtain NS₂ and EW₂, as described hereinabove).

Act 906 of flow diagram 900 includes utilizing the preprocessed data as input to a calibrated neural network, wherein the calibrated neural network is calibrated via transfer learning to perform Watson-Watt direction finding without utilizing a lookup table for error correction. In some instances, the calibrated neural network comprises a first calibrated neural network (e.g., corresponding to Network 1 of the ataNN2 network 200 of FIG. 2 after calibration is performed) and a second calibrated neural network (e.g., corresponding to Network 2 of the ataNN2 network 200 of FIG. 2 after calibration is performed).

In some implementations, the use of the first calibrated neural network and the second calibrated neural network of the calibrated neural network is determined by the polarity of the EW response (e.g., the sine pattern data, such as EW₁ or EW₂ obtained after the preprocessing/mapping described above). For instance, the calibrated neural network can be configured to: (i) process the preprocessed data as input using the first calibrated neural network when a sign of the sine pattern data is positive; and (ii) process the preprocessed data as input using the second calibrated neural network when the sign of the sine pattern data is negative. In some implementations, processing the preprocessed data as input using the second calibrated neural network comprises applying a sign change to the sine pattern data (e.g., Network 2 can invert the negative Y input such that the input processed is positive, as discussed hereinabove with reference to the ataNN2 network 200 shown in FIG. 2). In some examples, processing the preprocessed data as input using the second calibrated neural network comprises applying a post-process angle transformation to output of the second calibrated neural network (e.g., processing with Network 2 can include a −180° post-processing step, as indicated in FIG. 2 by the “Out −180°” following Network 2).

Act 908 of flow diagram 900 includes outputting angle of arrival data, the angle of arrival data comprising output of the calibrated neural network.

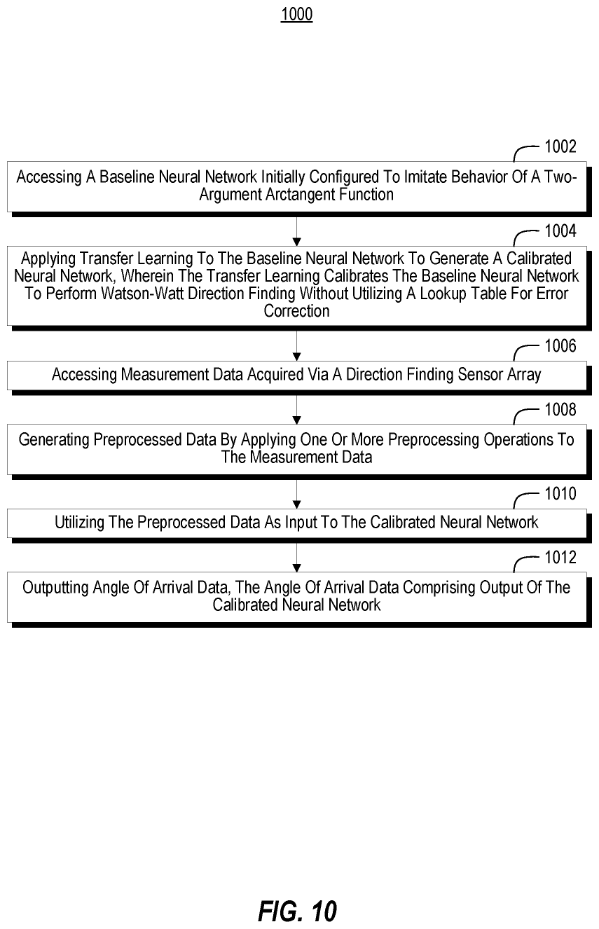

Act 1002 of flow diagram 1000 of FIG. 10 includes accessing a baseline neural network initially configured to imitate behavior of a two-argument arctangent function. The baseline neural network can correspond to an initially trained ataNN2 network (e.g., ataNN2 network 200) prior to calibration. In some instances, the baseline neural network comprises a first neural network and a second neural network (e.g., similar to Network 1 and Network 2 of the ataNN2 network 200 shown in FIG. 2). In some implementations, the first neural network and the second neural network comprise separate instances of a single initially trained neural network.

In some examples, the baseline neural network is configured to receive input comprising a sine pattern (e.g., yielded by EW elements) and a cosine pattern (e.g., yielded by NS elements).

In some instances, the use of the first neural network and the second neural network of the baseline neural network is determined by the polarity of the EW response (e.g., the sine pattern). For instance, the baseline neural network can be configured to: (i) process the input using the first neural network when a sign of the sine pattern is positive; and (ii) process the input using the second neural network when the sign of the sine pattern is negative. In some implementations, processing the input using the second neural network comprises applying a sign change to the sine pattern (e.g., Network 2 can invert the negative Y input such that the input processed is positive, as discussed hereinabove with reference to the ataNN2 network 200 shown in FIG. 2). In some examples, processing the input using the second neural network comprises applying a post-processing angle transformation to output of the second neural network (e.g., processing with Network 2 can include a −180° post-processing step, as indicated in FIG. 2 by the “Out −180°” following Network 2).

Act 1004 of flow diagram 1000 includes applying transfer learning to the baseline neural network to generate a calibrated neural network, wherein the transfer learning calibrates the baseline neural network to perform Watson-Watt direction finding without utilizing a lookup table for error correction. In some implementations, applying transfer learning to the baseline neural network comprises retraining the first neural network and the second neural network utilizing transfer learning data comprising measurement data and ground truth angle of arrival data. In some instances, the transfer learning data further comprises anchor point data associated with one or more beam peaks or one or more beam crossovers (e.g., for a four-element array, such as array 400, beam peaks for each element can comprise 0°, 90°, 180°, and 270°, and beam crossovers for each element pair can comprise 45°, 135°, 225°, and 315°).

Act 1006 of flow diagram 1000 includes accessing measurement data acquired via a direction finding sensor array. In some implementations, the direction finding sensor array can correspond to array 400 described hereinabove. For instance, the direction finding sensor array can comprise a uniform circular array of monopoles, and the uniform circular array of monopoles can comprise a four-element array. In some instances, the measurement data comprises radiation pattern data (e.g., example radiation pattern or measurement data acquired by different monopoles of an array 400 are shown in FIGS. 5A, 5B, 5C, and 5D).

Act 1008 of flow diagram 1000 includes generating preprocessed data by applying one or more preprocessing operations to the measurement data. In some examples, applying the one or more preprocessing operations to the measurement data comprises mapping the radiation pattern data to sine pattern data (e.g., to imitate sine patterns yielded by EW elements, such as EW₁) and cosine pattern data (e.g., to imitate cosine patterns yielded by NS elements, such as NS₁). In some instances, mapping the radiation pattern data to the sine pattern data and the cosine pattern data comprises (i) determining maximum power of different channel pairs (e.g., NS and EW channel pairs), (ii) changing polarity of at least one channel from each of the different channel pairs (e.g., the S and E channels can incur a polarity change), and, after changing polarity, fitting channel pair data to a unit circle via vector norm (e.g., to obtain NS₁ and EW₁, as described hereinabove). In some implementations, the one or more preprocessing operations comprise an offset removal operation (e.g., to obtain NS₂ and EW₂, as described hereinabove).

Act 1010 of flow diagram 1000 includes utilizing the preprocessed data as input to the calibrated neural network. In some instances, the calibrated neural network comprises a first calibrated neural network (e.g., corresponding to Network 1 of the ataNN2 network 200 of FIG. 2 after calibration is performed) and a second calibrated neural network (e.g., corresponding to Network 2 of the ataNN2 network 200 of FIG. 2 after calibration is performed).

In some implementations, the use of the first calibrated neural network and the second calibrated neural network of the calibrated neural network is determined by the polarity of the EW response (e.g., the sine pattern data, such as EW₁ or EW₂ obtained after the preprocessing/mapping described above). For instance, the calibrated neural network can be configured to: (i) process the preprocessed data as input using the first calibrated neural network when a sign of the sine pattern data is positive; and (ii) process the preprocessed data as input using the second calibrated neural network when the sign of the sine pattern data is negative. In some implementations, processing the preprocessed data as input using the second calibrated neural network comprises applying a sign change to the sine pattern data (e.g., Network 2 can invert the negative Y input such that the input processed is positive, as discussed hereinabove with reference to the ataNN2 network 200 shown in FIG. 2). In some examples, processing the preprocessed data as input using the second calibrated neural network comprises applying a post-process angle transformation to output of the second calibrated neural network (e.g., processing with Network 2 can include a −180° post-processing step, as indicated in FIG. 2 by the “Out −180°” following Network 2).

Act 1012 of flow diagram 1000 includes outputting angle of arrival data, the angle of arrival data comprising output of the calibrated neural network.

Embodiments disclosed herein can include those in the following numbered clauses:

Clause 1. A system for facilitating calibration of a direction finding system, the system comprising: one or more processors; and one or more computer-readable recording media that store executable instructions that are executable by the one or more processors to configure the system to: access a baseline neural network initially configured to imitate behavior of a two-argument arctangent function; apply transfer learning to the baseline neural network to generate a calibrated neural network, wherein the transfer learning calibrates the baseline neural network to perform Watson-Watt direction finding without utilizing a lookup table for error correction; and output the calibrated neural network.

Clause 2. The system of clause 1, wherein the baseline neural network comprises a first neural network and a second neural network.

Clause 3. The system of clause 2, wherein the first neural network and the second neural network comprise separate instances of a single initially trained neural network.

Clause 4. The system of clause 2, wherein the baseline neural network is configured to receive input comprising a sine pattern and a cosine pattern.

Clause 5. The system of clause 4, wherein the baseline neural network is configured to: process the input using the first neural network when a sign of the sine pattern is positive; and process the input using the second neural network when the sign of the sine pattern is negative.

Clause 6. The system of clause 5, wherein processing the input using the second neural network comprises applying a sign change to the sine pattern.

Clause 7. The system of clause 5, wherein processing the input using the second neural network comprises applying a post-processing angle transformation to output of the second neural network.

Clause 8. The system of clause 2, wherein applying transfer learning to the baseline neural network comprises retraining the first neural network and the second neural network utilizing transfer learning data comprising measurement data and ground truth angle of arrival data.

Clause 9. The system of clause 8, wherein the transfer learning data further comprises anchor point data associated with one or more beam peaks or one or more beam crossovers.

Clause 10. A system for performing direction finding, the system comprising: one or more processors; and one or more computer-readable recording media that store executable instructions that are executable by the one or more processors to configure the system to: access measurement data acquired via a direction finding sensor array; generate preprocessed data by applying one or more preprocessing operations to the measurement data; utilize the preprocessed data as input to a calibrated neural network, wherein the calibrated neural network is calibrated via transfer learning to perform Watson-Watt direction finding without utilizing a lookup table for error correction; and output angle of arrival data, the angle of arrival data comprising output of the calibrated neural network.

Clause 11. The system of clause 10, wherein the direction finding sensor array comprises a uniform circular array of monopoles.

Clause 12. The system of clause 11, wherein uniform circular array of monopoles comprises a four-element array.

Clause 13. The system of clause 10, wherein the measurement data comprises radiation pattern data, and wherein applying the one or more preprocessing operations to the measurement data comprises mapping the radiation pattern data to sine pattern data and cosine pattern data.

Clause 14. The system of clause 13, wherein mapping the radiation pattern data to the sine pattern data and the cosine pattern data comprises determining maximum power of different channel pairs, changing polarity of at least one channel from each of the different channel pairs, and, after changing polarity, fitting channel pair data to a unit circle via vector norm.

Clause 15. The system of clause 14, wherein the one or more preprocessing operations comprise an offset removal operation.

Clause 16. The system of clause 13, wherein the calibrated neural network comprises a first calibrated neural network and a second calibrated neural network.

Clause 17. The system of clause 16, wherein the calibrated neural network is configured to: process the preprocessed data as input using the first calibrated neural network when a sign of the sine pattern data is positive; and process the preprocessed data as input using the second calibrated neural network when the sign of the sine pattern data is negative.

Clause 18. The system of clause 17, wherein processing the preprocessed data as input using the second calibrated neural network comprises applying a sign change to the sine pattern data.

Clause 19. The system of clause 17, wherein processing the preprocessed data as input using the second calibrated neural network comprises applying a post-process angle transformation to output of the second calibrated neural network.

Clause 20. A direction finding system, comprising: a direction finding sensor array;

one or more processors; and one or more computer-readable recording media that store executable instructions that are executable by the one or more processors to configure the direction finding system to: access a baseline neural network initially configured to imitate behavior of a two-argument arctangent function; apply transfer learning to the baseline neural network to generate a calibrated neural network, wherein the transfer learning calibrates the baseline neural network to perform Watson-Watt direction finding without utilizing a lookup table for error correction; access measurement data acquired via the direction finding sensor array; generate preprocessed data by applying one or more preprocessing operations to the measurement data; utilize the preprocessed data as input to the calibrated neural network; and output angle of arrival data, the angle of arrival data comprising output of the calibrated neural network.

### Additional Details Related to Implementing the Disclosed Embodiments

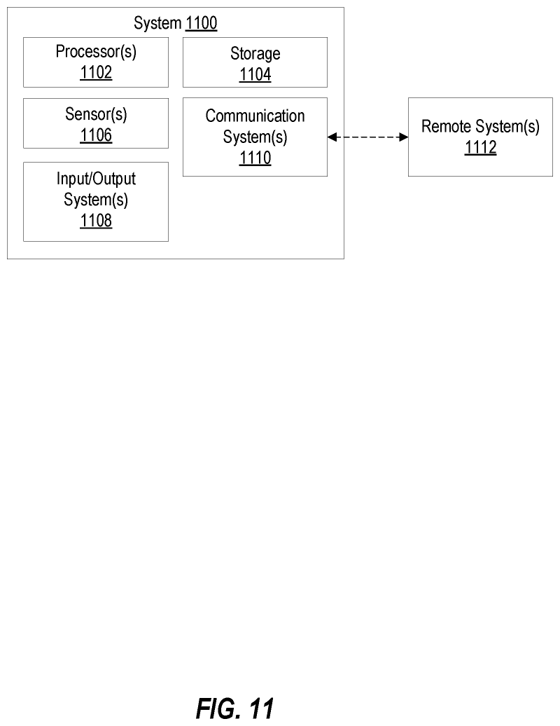

FIG. 11 illustrates example components of a system 1100 that may comprise or implement aspects of one or more disclosed embodiments. For example, FIG. 11 illustrates an implementation in which the system 1100 includes processor(s) 1102, storage 1104, sensor(s) 1106, I/O system(s) 1108, and communication system(s) 1110. Although FIG. 11 illustrates a system 1100 as including particular components, one will appreciate, in view of the present disclosure, that a system 1100 may comprise any number of additional or alternative components.

The processor(s) 1102 may comprise one or more sets of electronic circuitries that include any number of logic units, registers, and/or control units to facilitate the execution of computer-readable instructions (e.g., instructions that form a computer program). Such computer-readable instructions may be stored within storage 1104. The storage 1104 may comprise physical system memory or computer-readable recording media and may be volatile, non-volatile, or some combination thereof. Furthermore, storage 1104 may comprise local storage, remote storage (e.g., accessible via communication system(s) 1110 or otherwise), or some combination thereof. Additional details related to processors (e.g., processor(s) 1102) and computer storage media (e.g., storage 1104) will be provided hereinafter.

As will be described in more detail, the processor(s) 1102 may be configured to execute instructions stored within storage 1104 to perform certain actions. In some instances, the actions may rely at least in part on communication system(s) 1110 for receiving data from remote system(s) 1112, which may include, for example, separate systems or computing devices, sensors, and/or others. The communications system(s) 1110 may comprise any combination of software or hardware components that are operable to facilitate communication between on-system components/devices and/or with off-system components/devices. For example, the communications system(s) 1110 may comprise ports, buses, or other physical connection apparatuses for communicating with other devices/components. Additionally, or alternatively, the communications system(s) 1110 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 11 illustrates that a system 1100 may comprise or be in communication with sensor(s) 1106. Sensor(s) 1106 may comprise any device for capturing or measuring data representative of perceivable phenomenon. By way of non-limiting example, the sensor(s) 1106 may comprise one or more antennae, monopoles, image sensors, microphones, thermometers, barometers, magnetometers, accelerometers, gyroscopes, and/or others.

Furthermore, FIG. 11 illustrates that a system 1100 may comprise or be in communication with I/O system(s) 1108. I/O system(s) 1108 may include any type of input or output device such as, by way of non-limiting example, a display, a touch screen, a mouse, a keyboard, a controller, and/or others, without limitation.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable recording media, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that at least some aspects of the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, at least some of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is currently claimed is:

1. A system for facilitating calibration of a direction finding system, the system comprising:
one or more processors; and
one or more computer-readable recording media that store executable instructions that are executable by the one or more processors to configure the system to:
access a baseline neural network initially configured to imitate behavior of a two-argument arctangent function;
apply transfer learning to the baseline neural network to generate a calibrated neural network, wherein the transfer learning calibrates the baseline neural network to perform Watson-Watt direction finding without utilizing a lookup table for error correction; and
output the calibrated neural network.

2. The system of claim 1, wherein the baseline neural network comprises a first neural network and a second neural network.

3. The system of claim 2, wherein the first neural network and the second neural network comprise separate instances of a single initially trained neural network.

4. The system of claim 2, wherein the baseline neural network is configured to receive input comprising a sine pattern and a cosine pattern.

5. The system of claim 4, wherein the baseline neural network is configured to:
process the input using the first neural network when a sign of the sine pattern is positive; and
process the input using the second neural network when the sign of the sine pattern is negative.

6. The system of claim 5, wherein processing the input using the second neural network comprises applying a sign change to the sine pattern.

7. The system of claim 5, wherein processing the input using the second neural network comprises applying a post-processing angle transformation to output of the second neural network.

8. The system of claim 2, wherein applying transfer learning to the baseline neural network comprises retraining the first neural network and the second neural network utilizing transfer learning data comprising measurement data and ground truth angle of arrival data.

9. The system of claim 8, wherein the transfer learning data further comprises anchor point data associated with one or more beam peaks or one or more beam crossovers.

10. A system for performing direction finding, the system comprising:
one or more processors; and
one or more computer-readable recording media that store executable instructions that are executable by the one or more processors to configure the system to:
access measurement data acquired via a direction finding sensor array;
generate preprocessed data by applying one or more preprocessing operations to the measurement data;
utilize the preprocessed data as input to a calibrated neural network, wherein the calibrated neural network is calibrated via transfer learning to perform Watson-Watt direction finding without utilizing a lookup table for error correction; and
output angle of arrival data, the angle of arrival data comprising output of the calibrated neural network.

11. The system of claim 10, wherein the direction finding sensor array comprises a uniform circular array of monopoles.

12. The system of claim 11, wherein uniform circular array of monopoles comprises a four-element array.

13. The system of claim 10, wherein the measurement data comprises radiation pattern data, and wherein applying the one or more preprocessing operations to the measurement data comprises mapping the radiation pattern data to sine pattern data and cosine pattern data.

14. The system of claim 13, wherein mapping the radiation pattern data to the sine pattern data and the cosine pattern data comprises determining maximum power of different channel pairs, changing polarity of at least one channel from each of the different channel pairs, and, after changing polarity, fitting channel pair data to a unit circle via vector norm.

15. The system of claim 14, wherein the one or more preprocessing operations comprise an offset removal operation.

16. The system of claim 13, wherein the calibrated neural network comprises a first calibrated neural network and a second calibrated neural network.

17. The system of claim 16, wherein the calibrated neural network is configured to:
process the preprocessed data as input using the first calibrated neural network when a sign of the sine pattern data is positive; and
process the preprocessed data as input using the second calibrated neural network when the sign of the sine pattern data is negative.

18. The system of claim 17, wherein processing the preprocessed data as input using the second calibrated neural network comprises applying a sign change to the sine pattern data.

19. The system of claim 17, wherein processing the preprocessed data as input using the second calibrated neural network comprises applying a post-process angle transformation to output of the second calibrated neural network.

20. A direction finding system, comprising:
a direction finding sensor array;
one or more processors; and
one or more computer-readable recording media that store executable instructions that are executable by the one or more processors to configure the direction finding system to:
access a baseline neural network initially configured to imitate behavior of a two-argument arctangent function;
apply transfer learning to the baseline neural network to generate a calibrated neural network, wherein the transfer learning calibrates the baseline neural network to perform Watson-Watt direction finding without utilizing a lookup table for error correction;
access measurement data acquired via the direction finding sensor array;
generate preprocessed data by applying one or more preprocessing operations to the measurement data;
utilize the preprocessed data as input to the calibrated neural network; and
output angle of arrival data, the angle of arrival data comprising output of the calibrated neural network.
